(19) United States
(12) Patent Application Publication
(10) Pub. No.: US 2003/0147346 A1
(43) Pub. Date: Aug. 7, 2003

(54) Label switching router, label switching network and label switched path setting method

(75) Inventor: Katsuya Kanakubo, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/350,955

(22) Filed: Jan. 27, 2003

(30) Foreign Application Priority Data
Feb. 1, 2002 (JP) 2002-025989

(51) Int. Cl. H04J 1/16; H04J 3/14

(52) U.S. Cl. 370/227; 370/228

(57) ABSTRACT

To provide a label switching network in which the network resources and the operation cost can be reduced, and the scalability problem to a large scale network can be solved.

If an LSR detects a fault in the label switched path, the LSR retrieves an LSP fault indication retrieval table to solve an LSP fault of what contents to be notified to which protection point for a faulty label switched path. After solving it, the LSR notifies the LSP fault indication to the protection point. In the LSR-P of protection point, if an LSP fault indication packet from the LSR having detected the LSP fault is received, the label switched path to be switched is designated from the information contained in that message, and the switching of the corresponding label switched path is performed.

### BACKGROUND OF THE INVENTION

1. Field of the Invention

The present invention relates to a label switching router, a label switching network and a label switched path setting method and, more particularly, to a label switched path setting method in an MPLS (Multi-Protocol Label Switching) network.

2. Description of the Prior Art

In a label switched path (LSP) (referred to as a Static LSP) which is established by setting a label value in each label switching router (LSR) constituting an MPLS network manually (with a command) by an operator, there is no signaling regarding the label switched path between the label switching routers.

Therefore, a fault of the label switched path is only detected by each label switching router (LSR) that locally exists. If an LSP bypass (LSP protection) function is provided, it is required to establish a bypass path “d1” from LSR21 to LSR24 to LSR25 to LSR26, a bypass path “c1” from LSR22 to LSR24 to LSR25 to LSR26, or a bypass path “b1” from LSR23 to LSR25 to LSR26 for a label switched path for protection “A” (indicated by the heavy line in FIG. 7) in the label switching routers 21 to 26, as shown in FIG. 7.

For example, if LSR23 detects a fault in the line b to LSR26, the bypass path “b1” from LSR23 to LSR25 to LSR26 is established, if LSR22 detects a fault in the line “c” to LSR23, the bypass path “c1” from LSR22 to LSR24 to LSR25 to LSR26 is established, and if LSR21 detects a fault in the line “d” to LSR22, the bypass path “d1” from LSR21 to LSR24 to LSR25 to LSR26 is established.

### BRIEF SUMMARY OF THE INVENTION

In the conventional MPLS network as above described, the number of label switching routers constituting it is increased as the network scale is greater. Thus, the label value is correspondingly set up manually (with a command) by the operator, and each label switched path for protection must be established.

Some MPLS networks involve the use of a method for automatically establishing the label switched path by exchanging the control packets between the label switching routers. However, with this method, the number of label switched paths is increased as the network scale is greater, whereby it is required to transmit a control packet to each of the increased label switched paths, causing an increase in the traffic, resulting in the scalability problem or the problem associated with shortage of network resources.

In this case, if a fault in the label switched path is detected, a control packet for that is needed for each of the label switched paths, a switching process has more load due to increased control packets to inhibit the fast switching, resulting in the problem that the interruption for switching service is longer.

Thus, the present invention has been achieved to solve the above-mentioned problems, and it is an object of the invention to provide a label switching router, a label switching network and a label switched path setting method in which the network resources and the operation cost can be reduced, and the scalability problem to a larger scale network can be solved.

The present invention provides a label switching router in a label switching network which is operated by setting a label switchied path between routers with a command, comprising means for detecting a fault in the label switched path, means for notifying a fault detection indication to a preset bypass point, and means for suitching the label switchied path on the basis of message contents when receiving the fault detection indication from other routers.

The present invention provides a label switching network that is operated by setting a label switched path between the label switching routers with a command, the label switching router comprising means for detecting a fault in the label switched path, means for notifying a fault detection indication to a preset bypass point, and means for switching the label switched path on the basis of message contents when receiving the fault detection indication from other label switching routers.

Also, this invention provides a label switched path setting method for a label switching network that is operated by setting a label switched path between the label switching routers with a command, the label switching router comprising a step of detecting a fault in the label switched path, a step of notifying a fault detection indication to a preset bypass point, and a step of switching the label switched path on the basis of message contents when receiving the fault detection indication from other label switching routers.

That is, for the label switching network, a remote fault detecting function in the Static-LSP (Label Switched Path) is offered to solve the above-mentioned problems. Associated with this, an LSP protection function is enabled to flexibly cope with the operation policy [Diff-serv (differentiated service) class, band, service] for the MPLS (Multi-Protocol Label Switching) network.

The label switching network of the invention has a fault detecting function for the label switched path (LSP) and a protecting function for the label switched path in the MPLS network. Thereby, in the Static-LSP that detects a remote fault of the Static-LSP established manually (with a command) by the operator and enables the LSP protection for a local fault, the LSP protection is implemented at the time of remote fault.

Thus, in the label switching network of the invention, when the LSP protection of the existent Static-LSP is provided, it is necessary to establish an alternate path for all the label switching routers (LSRs) constituting the MPLS network. However, if a fault is detected at any point of the Static-LSP, and this LSP fault indication (Fault-Indication) is notified to remote LSP protection point, the protection path needed to be set for each label switching router is intensive, whereby the network resources or management cost can be reduced.

The indication contents of the Fault-Indication may include the settable operation policy, whereby the LSP protection is enabled for not only the conventional fixed protection in a unit of label switched path, but also the protection according to the QoS (Quality of Service) policy or the VPN (Virtual Private Network), and the protection for a collection of plural label switched paths. Thereby, with this invention, it is possible to reduce the load of the switching process and effect the fast switching, resulting in shorter service interruption for switching.

### BRIEF DESCRIPTION OF THE DRAWINGS

FIG. 1 is a block diagram showing the configuration of an MPLS network according to one embodiment of the present invention;

FIG. 2 is a block diagram showing a configuration example of a label switching router of FIG. 1;

FIG. 3 is a diagram showing a configuration example of an LSP fault indication retrieval table of FIG. 2;

FIG. 4 is a chart showing a format example of an LSP fault indication packet employed in the embodiment of the invention;

FIG. 5 is a diagram showing a normal operation state of an MPLS network according to the embodiment of the invention;

FIG. 6 is a flowchart showing a processing operation of the LSR of FIG. 1; and

FIG. 7 is a block diagram showing the configuration of the conventional MPLS network.

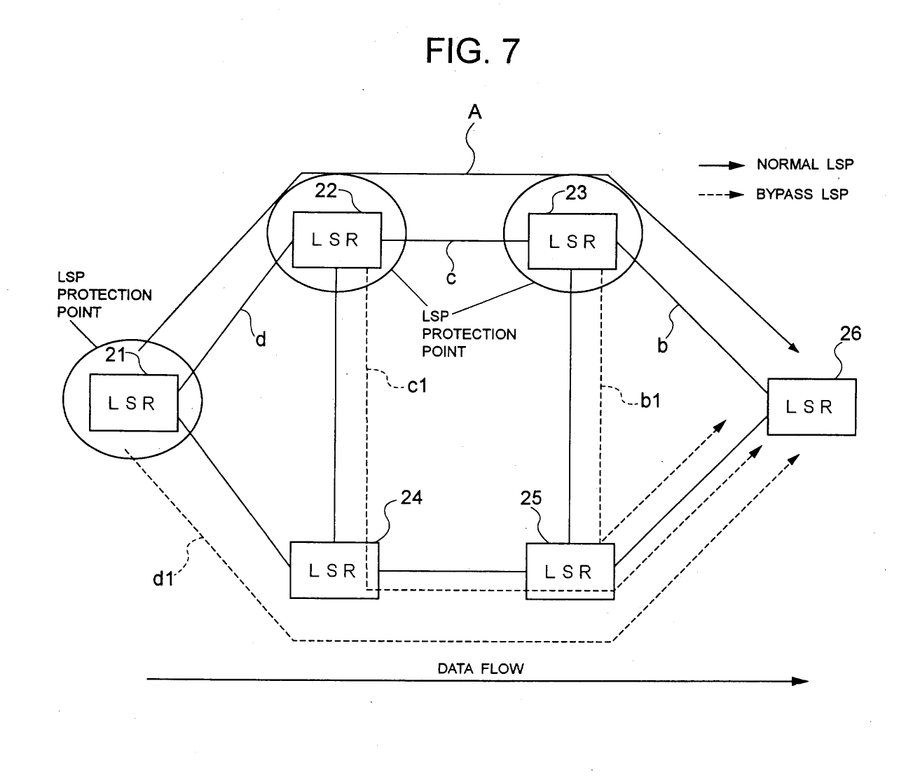

### DETAILED DESCRIPTION OF THE PREFERRED EMBODIMENTS

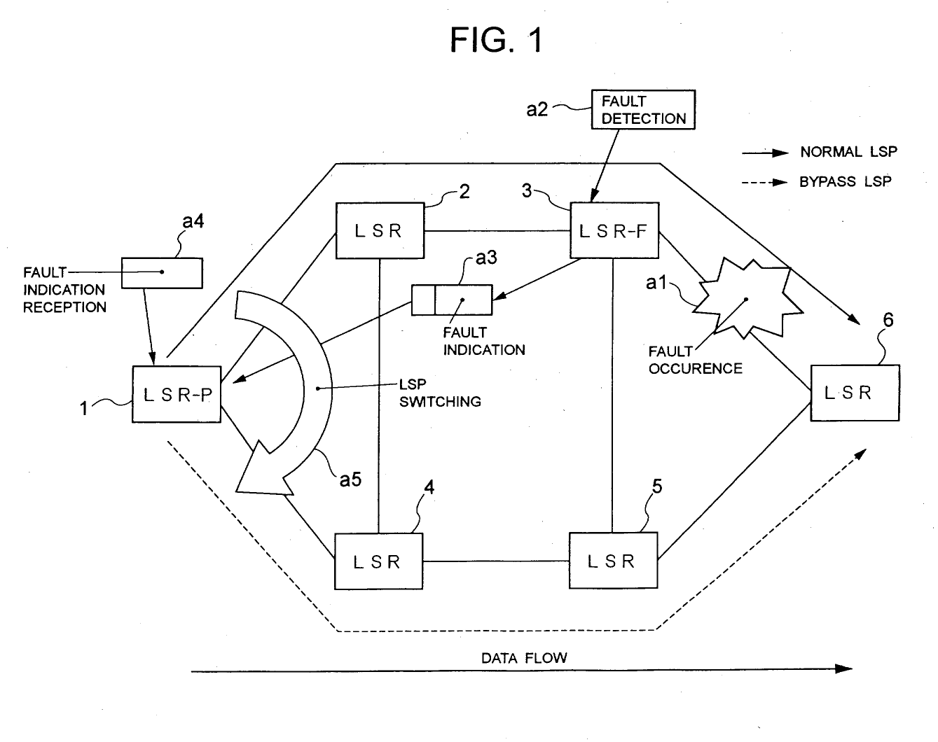

The preferred embodiments of the present invention will be described below with reference to the accompanying drawings. FIG. 1 is a block diagram showing the configuration of an MPLS (Multi-Protocol Label Switching) network according to one embodiment of the present invention. In FIG. 1, the MPLS network according to one embodiment of the invention has the label switching routers (LSRs) 1 to 6 and the label switched paths (LSPs) settable between those label switching routers. Herein, a label switching router 1 is an LSP-P (Protection) that is a protection (bypass) point, and a label switching router 3 is an LSR-F (Fault) having detected a fault.

In the MPLS network according to one embodiment of the invention, a Static LSP is presupposed in which a label value is set up in each of the label switching routers 1 to 6 manually (with a command) by the operator to establish the LSP.

In the case where a fault occurrence “a1” of label switched path is detected in the label switching router (LSP-F) 3 other than the label switching router (LSP-P) 1 of the protection point (“a2” in FIG. 1), the label switching router (LSP-F) 3 retrieves an LSP fault indication retrieval table (not shown, hereinafter described) held to solve the LSP fault of what contents to be notified to which protection point for a faulty label switched path.

After solving that, the label switching router (LSR-F) 3 forwards an indication packet “a3” for LSP fault indication to the protection point (label switching router (LSR-P) 1 in this case).

This LSP fault indication retrieval table is made out in advance on the basis of an operation policy [Diff-serv (differentiated service) class, band, service] by the operator. The LSP fault indication packet “a3” to the protection point is configured to contain the information necessary for protection (bypass) of the label switched path. It is required that this LSP fault indication packet is well defined between the transmitting side and the receiving side.

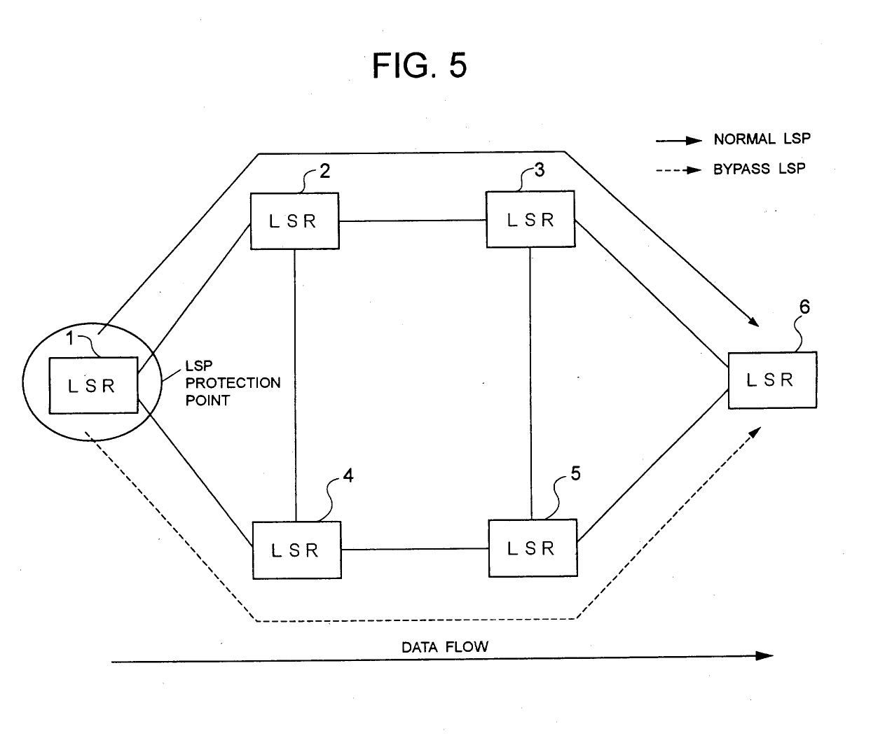

If the label switching router (LSR-P) 1 of protection point receives an LSP fault indication packet from the label switching router (LSR-F) 3 having detected the LSP fault (“a4” in FIG. 1), a label switched path to be switched is designated from the information contained in that message, and the switching of the corresponding label switched path is performed (“a5” in FIG. 5).

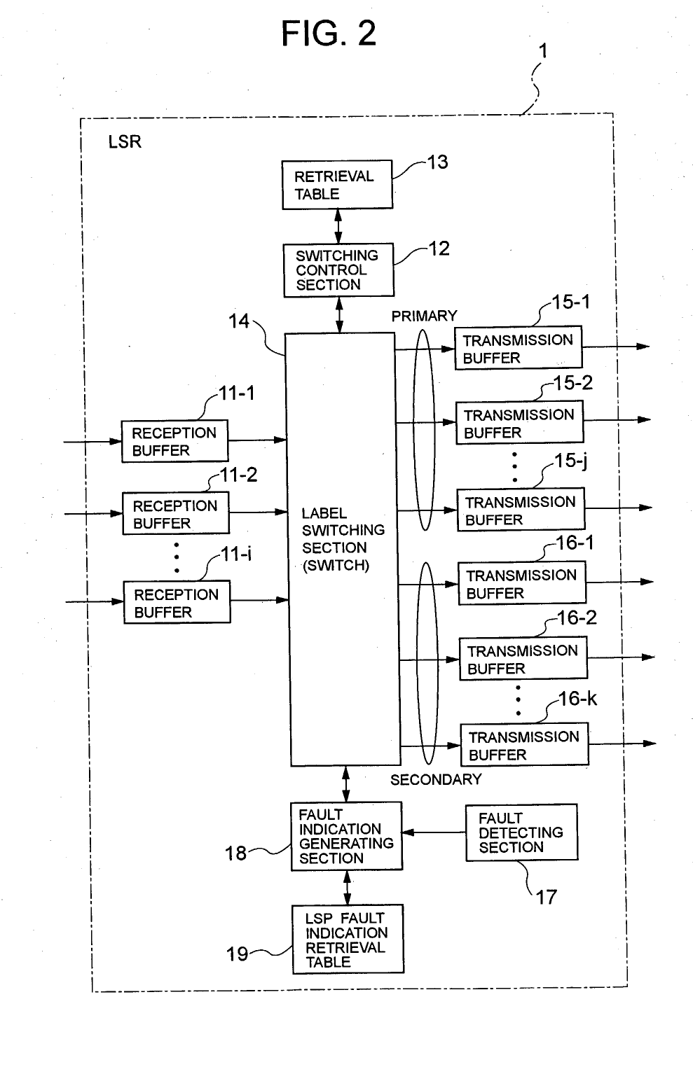

FIG. 2 is a block diagram showing a configuration example of the label switching router (LSR-P) 1 of FIG. 1. In FIG. 2, the label switching router 1 comprises the reception buffers 11-1 to 11-i, a switching control section 12, a retrieval table 13, a label switching section 14, the primary transmission buffers 15-1 to 15-j, the secondary transmission buffers 16-1 to 16-k, a fault detecting secting 17, a fault indication generating section 18, and an LSP fault indication retrieval table 19.

In the label switching router 1, packets received via input lines are temporarily stored in the reception buffers 11-1 to 11-i, each of the appended label values is replaced in the label switching section 14, and the packets are transmitted from the transmission buffers 15-1 to 15-j and 16-1 to 16-k corresponding to the label values before replacement to output lines.

Replacement of the label value in the label switching section 14 is made according to the retrieval result for the retrieval table 13 by the switching control section 12. The switching control section 12 controls the label switching section 14, and makes the selection of the transmission buffers 15-1 to 15-j and 16-1 to 16-k and the switching between primary and secondary. In this case, the switching control section 12 controls the switching between primary and secondary according to the contents of the LSP fault indication, upon receiving an LSP fault indication from other label switching routers 2 to 6.

The fault detecting section 17 detects a remote fault in the Static-LSP, detects a fault in the line under normal monitoring, and detects a fault due to fault indication from the upper level protocol [e.g., SDH (Synchronous Digital Hierarchy) or ATM (Asynchronous Transfer Mode)]. If detecting any fault, the fault detecting section notifies its fault status to the fault indication generating section 18.

Herein, the fault types, though depends on the mounting contents of apparatus, includes an SDH or PPP (Point-to-Point Protocol) fault for POS [Packet Over SONET (Synchronous Optical NETwork)], an SDH, VP (Virtual Path), VC (Virtual Channel) fault for ATM, and a link fault for Ethernet (R).

If the fault indication generating section 18 is notified of the detection of a fault from the fault detecting section 17, it retrieves the LSP fault indication retrieval table 19 on the basis of its fault position, generates an LSP fault indication from its retrieval result, and transmits the LSP fault indication to the label switching router of protection point designated in the LSP fault indication retrieval table 19.

The LSP fault indication retrieval table 19 is made out in advance by the operator on the basis of the operation policy [Diff-serv (differentiated services) class, band and service]. That is, the LSP fault indication retrieval table 19 contains the information necessary for bypass of the label switched path at the protection point in accordance with the fault of label switched path and stores the information of preset operation policy.

In the above description, the configuration and operation of the label switching router 1 have been described, but the configuration and operation of other label switching routers 2 to 6, like the label switching router 1, will not be described. In the label switching routers 1 to 6 having the above configuration, if a fault in the line is detected, the LSR-F having detected the fault is defined, and if designated as the protection point, the LSR-P of protection point is defined.

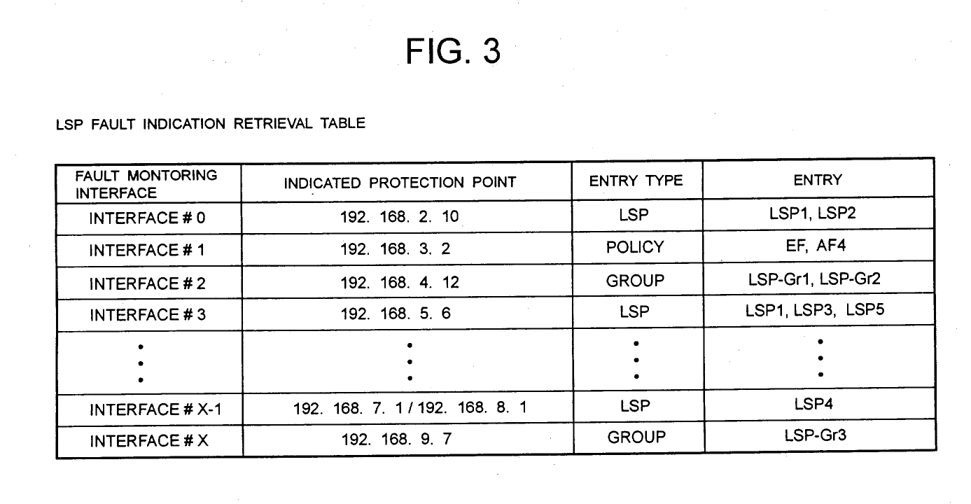

FIG. 3 is a diagram showing a configuration example of an LSP fault indication retrieval table 19 of FIG. 2. In FIG. 3, the LSP fault indication retrieval table 19 stores the “INDICATED PROTECTION POINT”, “ENTRY TYPE” and “ENTRY” corresponding to “FAULT MONITORING INTERFACE”.

For example, “192. 168.2. 10” as the “indicated protection point”, “LSP” as “entry type”, and “LSP1, LSP2” as the “entry” are stored in a memory area corresponding to interface#0. Namely, when a fault is detected in the interface #0, an LSP fault indication is sent to the protection point of “192. 168.2. 10” to bypass LSP1 and LSP2.

In a memory area corresponding to interface #1, “192.168.3. 2” as the “INDICATED PROTECTION POINT”, “POLICY” as “ENTRY TYPE”, and “EF.AF4 (Diff-serv class name)” as the “ENTRY” are stored. Namely, when a fault is detected in the interface #1, an LSP fault indication is sent to the protection point of “192. 168.3. 2” to stop the service of EF.AF4.

In a memory area corresponding to interface #2, “192. 168.4. 12” as the “INDICATED PROTECTION POINT”, “GROUP” as “ENTRY TYPE”, and “LSP-Gr1, LSP-Gr2” as the “ENTRY” are stored. Namely, when a fault is detected in the interface #2, an LSP fault indication is sent to the protection point of “192. 168.4. 12” to bypass an LSP group of LSP-Gr1 and LSP-Gr2 collectively.

In a memory area corresponding to interface #3, “192. 168.5. 6” as the “INDICATED PROTECTION POINT”, “LSP” as “ENTRY TYPE”, and “LSP1, LSP3, LSP5” as the “ENTRY” are stored. Namely, when a fault is detected in the interface #3, an LSP fault indication is sent to the protection point of “192. 168.5. 6” to bypass LSP1, LSP3 and LSP5.

Further, in a memory area corresponding to interface #X-1, “192. 168.7. 1/192.168.8.1” as the “INDICATED PROTECTION POINT”, “LSP” as “ENTRY”, and “LSP4” as the “ENTRY” are stored. Namely, when a fault is detected in the interface #X-1, an LSP fault indication is sent to the protection point of “192. 168.7.1/192.168.8.1” to bypass LSP4.

Likewise, in a memory area corresponding to interface #X, “192. 168.9. 7” as the “INDICATED PROTECTION POINT”, “GROUP” as “ENTRY TYPE”, and “LSP-Gr3” as the “ENTRY” are stored. Namely, when a fault is detected in the interface #X, an LSP fault indication is sent to the protection point of “192. 168.9.7” to bypass a group of LSP-Gr3 collectively.

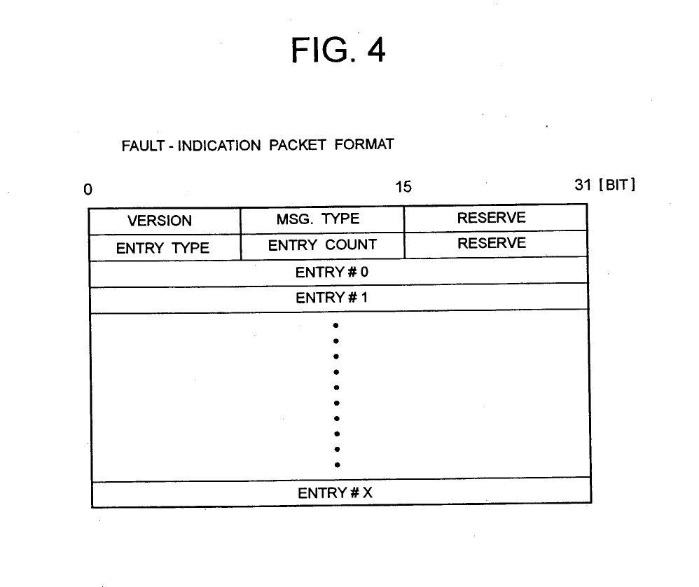

FIG. 4 is a chart showing a format example of an LSP fault indication packet employed in the embodiment of the invention. In FIG. 4, an LSP fault indication packet includes the items of version (VERSION), message type (MSG. TYPE), entry type (ENTRY TYPE), entry counter (ENTRY COUNTER), entries (ENTRY #0 to ENTRY #X) defined by the number of entries that is designated by its entry counter, and reserve area (RESERVE).

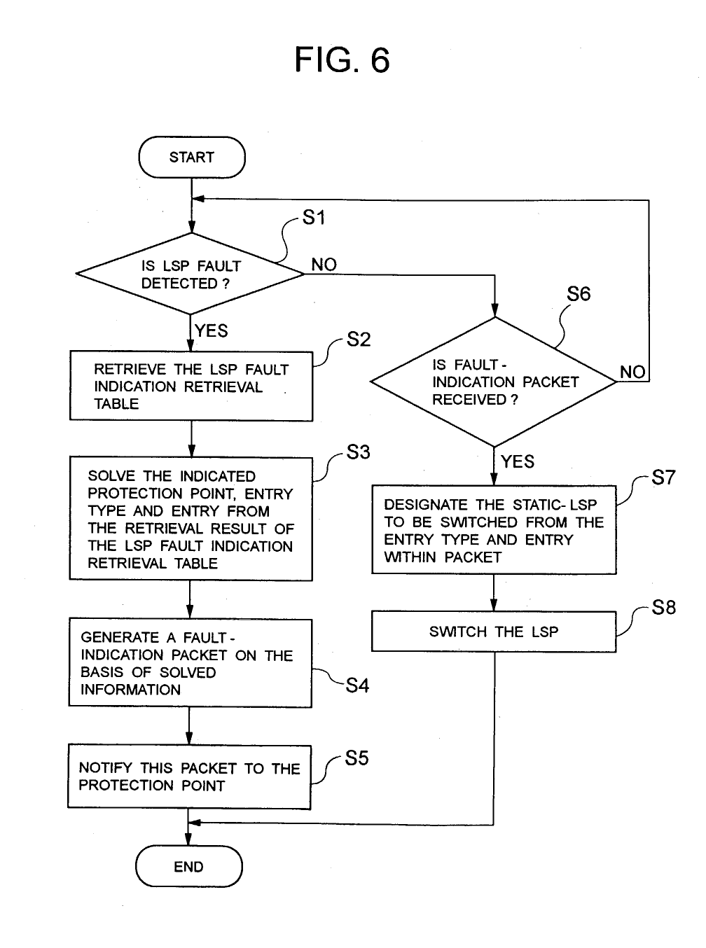

FIG. 5 is a diagram showing a normal operation state of an MPLS network according to the embodiment of the invention, and FIG. 6 is a flowchart showing a processing operation of the label switching routers 1 to 6 of FIG. 1. Referring to FIGS. 1 to 6, the operation of the MPLS network according to one embodiment of the invention will be described below.

If an LSP fault occurrence is detected in the label switching router (LSR-F) 3 in the normal operation state of the MPLS network as shown in FIG. 5, a series of processings from “LSP fault occurrence a1” to “LSP fault occurrence detection a3” via “LSP fault indication a2” are performed as shown in FIG. 1.

If the label switching router (LSR-F) 3 detects an LSP fault (step S1 in FIG. 6), the LSP fault indication retrieval table 19 is retrieved using the retrieval key of “interface where the LSP fault is detected” as shown in FIG. 3 (step S2 in FIG. 6).

The label switching router (LSR-F) 3 solves the “INDICATED PROTECTION POINT”, “ENTRY TYPE” and “ENTRY” from the retrieval result of the LSP fault indication retrieval table 19 (step S3 in FIG. 6).

The label switching router (LSR-F) 3 generates an LSP fault indication packet (Fault-Indication packet) of FIG. 4 on the basis of the solved information (step S4 in FIG. 6), and notifies it to the label switching router (LSR-P) 1 of protection point (step S5 in FIG. 6).

In accordance with the IP (Internet Protocol) as a basis in the lower level layer (network layer), the LSP fault indication packet is sent to the “INDICATED PROTECTION POINT” (label switching router (LSR-P) 1 in this case) having the IP destination address solved by the LSP fault indication retrieval table 19 as shown in FIG. 3.

In the label switching router (LSR-P) 1, if the LSP fault indication packet is received (step S6 in FIG. 6), the Static-LSP to be switched is specified from the entry type (ENTRY TYPE) and the entry (ENTRY) within its message (step S7 in FIG. 6), and the switching of the corresponding label switched path is performed (step S8 in FIG. 6).

The label switched path may not be necessarily set up directly in the entry type and the entry in the message of this LSP fault indication packet. In an example as shown in FIG. 3, the operation policy is defined, and notified from the label switching router (LSR-F) 3 to the label switching router (LSR-P) 1, and the label switched path according to the operation policy is retrieved in the label switching router (LSR-P) 1.

In the case where many label switched paths are to be switched, a group of label switched paths is defined in order to reduce the overhead regarding the message of the LSP fault indication packet. The group is notified with the LSP fault indication packet, and the switching of many label switched paths (e.g., switching from primary to secondary, which may involve replacement of the label value in this case) is collectively made.

That is, there is no need for the control packet for each label switched path in this example, as compared with when the label switched path is automatically established as conventionally, whereby the switching process does not have the increased load due to increased control packets, so that the fast switching can be made, and the service interruption can be shortened. Naturally, it is possible to suppress the increase in the traffic with the control packets. The “message type” of the LSP fault indication packet as shown in FIG. 4 has defined an area for indication at the time of recovery from the fault in the future.

In this manner, even when the Static-LSP is at the remote LSP fault, the label switched path can be switched by notifying this LSP fault to the protection point in this example. Thereby, there is no need for establishing the label switched path for bypass in each label switching router to detect the local LSP fault, whereby the network resources or the operation cost can be reduced, and the scalability problem to the large scale network can be solved.

Moreover, the indication contents defined by the LSP fault indication (Fault-Indication) is varied depending on the fixed information of the label switched path as well as the operation policy, and the flexible switching operation can be made, including switching the label switched path established on the basis of a certain policy.

Moreover, since the LSP fault indication can be intensive, it is possible to reduce the overhead of the label switched path switching process through the LSP fault indication process, even when many label switched path faults occur, whereby the fast switching of the label switched path can be made and the service interruption using the label switched path can be suppressed to the minimum.

In this example, the label switched path is designated in the entry within the message of the LSP fault indication. However, it is possible to designate not only the label switched path but also the operation policy (e.g., QoS policy), the label switched path to be switched is applicable to not only the Static-LSP but also the label switched path established by signaling.

As above described, this invention provides a label switching network that is operated by setting a label switched path between the label switching routers. When the label switching router detects a fault in the label switched path, a fault detection indication is notified to a preset bypass point, and the label switching router at the bypass point switches the label switched path on the basis of the message contents when receiving the fault detection indication. Thereby, the network resources and the operation cost can be reduced, giving rise to the effect that the scalability problem to a large scale network can be solved.

What is claimed is:

1. A label switching router in a label switching network which is operated by setting a switched path between routers with a command, comprising:
means for detecting a fault in said label switched path;
means for notifying a fault detection indication to a preset bypass point; and
means for switching said label switched path on the basis of message contents when receiving said fault detection indication from other routers.

2. The label switching router according to claim 1, wherein said means for detecting the fault detects a remote fault in the label switched path established with said command.

3. The label switching router according to claim 1, further comprising:
an LSP fault indication retrieval table storing the information for solving the fault indication of what contents to be notified to which bypass point for a faulty lavel switched path.

4. The label switching router according to claim 3, wherein said LSP fault indication retrieval table contains the information necessary for bypass of said label switched path at said bypass point corresponding to the fault of said label switched path, and stores the information of a preset operation policy.

5. The label switching router according to claim 1, wherein said fault detection indication contains the information necessary for bypass of said label switched path for said bypass point.

6. The label switching router according to claim 1, wherein said fault detection indication contains the information necessary for setting up the operation policy for said bypass point.

7. The label switching router according to claim 1, wherein said fault detection indication contains the information necessary for designating a group of label switched paths predefined for said bypass point.

8. The label switching router according to claim 5, wherein said means for switching said label switched path specifies the labal switched path to be switched from the information contained in said fault detection indication.

9. A label switching network that is operated by setting a label switched path between label switching routers with a command, said label switching router comprising:
means for detecting a fault in said label switched path;
means for notifying a fault detection indication to a preset bypass point; and
means for switching said label switched path on the basis of message contents when receiving said fault detection indication from other label switching routers.

10. The label switching network according to claim 9, wherein said label switching network is an MPLS (Multi-Protocol Label Switching) network.

11. The label switching network according to claim 9, wherein said means for detecting the fault detects a remote fault in the label switched path established with said command.

12. The label switching network according to claim 9, wherein said label switching router comprises an LSP fault indication retrieval table storing the information for solving the fault indication of what contents to be notified to which bypass point for a faulty label switched path.

13. The label switching network according to claim 12, wherein said LSP fault indication retrieval table contains the information necessary for bypass of said label switched path at said bypass point corresponding to the fault of said label switched path, and stores the information of a preset operation policy.

14. The label switching network according to claim 9, wherein said fault detection indication contains the information necessary for bypass of said label switched path for said bypass point.

15. The label switching network according to claim 9, wherein said fault detection indication contains the information necessary for setting up the operation policy for said bypass point.

16. The label switching network according to claim 9, wherein said fault detection indication contains the information necessary for designating a group of label switched paths predefined for said bypass point.

17. The label switching network according to claim 14, wherein said means for switching said label switched path specifies the label switched path to be switched from the information contained in said fault detection indication.

18. A label switched path setting method for a label switching network that is operated by setting a label switched path between label switching routers with a command, said label switching router comprising:
a step of detecting a fault in said label switched path;
a step of notifying a fault detection indication to a preset bypass point; and
a step of switching said label switched path on the basis of message contents when receiving said fault detection indication from other label switching routers.

19. The label switched path setting method according to claim 18, wherein said label switching network is an MPLS (Multi-Protocol Label Switching) network.

20. The label switched path setting method according to claim 18, wherein said step of detecting the fault detects a remote fault in the label switched path established with said command.

21. The label switched path setting method according to claim 18, wherein said fault detection indication is generated on the basis of an LSP fault indication retrieval table storing the information for solving the fault indication of what contents to be notified to which bypass point for a faulty label switched path.

22. The label switched path setting method according to claim 21, wherein said LSP fault indication retrieval table contains the information necessary for bypass of said label switched path at said bypass point corresponding to the fault of said label switched path, and stores the information of a preset operation policy.

23. The label switched path setting method according to claim 18, wherein said fault detection indication contains the information necessary for bypass of said label switched path for said bypass point.

24. The label switched path setting method according to claim 18, wherein said fault detection indication contains the information necessary for setting up the operation policy for said bypass point.

25. The label switched path setting method according to claim 18, wherein said fault detection indication contains the information necessary for designating a group of label switched paths predefined for said bypass point.

26. The label switched path setting method according to claim 23, wherein said step of switching said label switched path specifies the label switched path to be switched from the information contained in said fault detection indication.
